(19) United States
(12) Patent Application Publication
(10) Pub. No.: US 2007/0071274 A1
(43) Pub. Date: Mar. 29, 2007

(54) Insert moulded surround with integrated lead-out wires

(76) Inventors: Morten Kjeldsen Andersen, Odder (DK); Leif Johannsen, Odder (DK)

Correspondence Address: JENKENS & GILCHRIST, P.C., 225 WEST WASHINGTON, SUITE 2600, CHICAGO, IL, 60606, US

(21) Appl. No.: 11/525,005

(22) Filed: Sep. 21, 2006

Related U.S. Application Data
(60) Provisional application No. 60/719,043, filed on Sep. 21, 2005.

(51) Int. Cl. H04R 9/06

(52) U.S. Cl. 381/404

(57) ABSTRACT

The present invention relates to a suspension member for a diaphragm and to an electro-acoustic transducer applying such suspension member. The suspension member comprises an inner portion being adapted to be attached to a piston, an outer portion being adapted to be coupled to a substantially stationary portion of an associated electro-acoustic transducer, and a flexible member connecting the inner and outer portions. The flexible member comprises at least one electrically conducting element adapted to transport electrical signals across the suspension member.

### CROSS REFERENCE TO RELATED APPLICATIONS

This application claims the benefit of priority of U.S. Provisional Patent Application No. 60/719,043, filed Sep. 21, 2005, which is hereby incorporated by reference in its entirety.

### FIELD OF THE INVENTION

The present invention relates to a moulded surround with integrated lead-out wires. In particular, the present invention relates to moulded surround of silicone, rubber, or any other soft material. In addition, the present invention relates to a custom designed diaphragm being constituted by a soft surround and a significantly stiffer piston of, for example, a polyimide, aluminium, nylon, or flex print.

### BACKGROUND OF THE INVENTION

PCT Publication No. WO 2005/055657 relates, in general, to methods for manufacturing vibrators for electro-acoustic transducers and, more particularly, to a method of manufacturing a vibrator for an electro-acoustic transducer, such as a miniature loudspeaker to be used in mobile communication terminals, in which an edge support is integrally formed around a circumferential border of a diaphragm through silicone injection moulding.

The method of manufacturing a vibrator for electro-acoustic transducers which has a diaphragm that vibrates in response to an electric signal and an edge support integrally provided around a circumferential border of the diaphragm to support the diaphragm comprises the following steps; 1) preparing the diaphragm having a predetermined shape by shaping and cutting a synthetic resin or metal film into a predetermine shape, 2) applying a liquid primer to the diaphragm, 3) drying the diaphragm coated with the liquid primer, 4) inserting the diaphragm into a mould of an insert moulding apparatus, and 5) injecting silicone into the mould of the insert moulding apparatus and thereby integrally forming the edge support into a predetermined shape around the circumferential border of the diaphragm through insert injection moulding.

PCT Publication No. WO 2005/055657 also relates to a moulding apparatus in which edges and borders of a diaphragm may be integrally formed.

It is a disadvantage of the edge supports and diaphragms suggested in PCT Publication No. WO 2005/055657 that electrical leads to, for example, electrical coils attached to the piston, are vulnerable due to movements of the diaphragm.

Thus, it may be seen as an object of the present invention to provide an arrangement where electrical signals can be communicated across a flexible surround without exposing the wires carrying the electrical signal to unnecessary risks.

### SUMMARY OF THE INVENTION

The above-mentioned object is complied with by providing, in a first aspect, an electro-acoustic transducer comprising
a displaceable diaphragm comprising a suspension member and a piston, wherein the suspension member comprises
an inner portion supporting the piston,
an outer portion secured to a substantially stationary portion of the electro-acoustic transducer, and
a flexible member connecting the inner and outer portions, the flexible member comprising at least one electrically conducting element adapted to transport electrical signals across the suspension member
an electro-mechanical motor adapted to generate an electrical output signal in response to displacements of the diaphragm, or to displace the diaphragm in response to an electrical input signal.

In the following the suspension member will also be denoted as a surround. The electro-mechanical motor may be operated in two modes of operation. In a first mode of operation the electro-mechanical motor may be adapted to generate an electrical output signal in response to displacements of the diaphragm due to pressure variations, such as audible sound pressures, in the environment surrounding the electro-acoustic transducer. In this first mode of operation the electro-acoustic transducer is operated as a microphone, preferably a miniature microphone. In another mode of operation, the electro-mechanical motor is adapted to receive an incoming electrical signal and, in response to this, generate an audible acoustical signal by displacing the diaphragm in response to the electrical input signal. In this second mode of operation the electro-acoustic transducer is operated as a speaker, preferably a miniature speaker.

The electro-mechanical motor may, in general, be implemented as a moving coil arrangement or a moving magnet arrangement. In the moving coil arrangement the electro-mechanical motor may comprise a magnetic circuit adapted to generate a magnetic flux in an air gap. In addition, an electrically conducting voice coil comprising first and second end portions may be provided. The voice coil may be operatively connected to the diaphragm and, at least partly, positioned in the air gap. The first and second end portions of the voice coil are preferably electrically connected to first and second electrically conducting elements, respectively.

In a moving magnet arrangement, the electro-mechanical motor may comprise means for generating a magnetic field in response to an electrical input signal. In addition, a mechanical drive member operatively connected to the diaphragm may be provided, said mechanical drive member being movable in response to the electrical input signal. Thus, in response to the electrical input signal the mechanical drive member causes a displacement of the diaphragm. This type of motor is often referred to as a moving armature arrangement.

The inner portion of the suspension member may comprise an inner edge attached to an associated outer edge of the piston. Thus, according to this embodiment the inner edge of the suspension member forms a through-going opening prior to the piston being attached to the suspension member. Alternatively, the inner portion of the suspension member may comprise a supporting surface attached to an associated surface portion of the piston. The supporting surface of the suspension member may comprise an essentially plane surface portion. According to this embodiment the suspension member comprises a supporting surface to which the piston may be glued, welded, or by other means attached.

The at least one electrically conducting element may be at least partly embedded into the flexible member. The flexible member may be manufactured of a material selected from the group consisting of: silicone, rubber, or any combination thereof.

In a second aspect, the present invention relates to a suspension member for a diaphragm, the suspension member comprising:
an inner portion being adapted to support a piston,
an outer portion being adapted to be secured to a substantially stationary portion of an associated electro-acoustic transducer, and
a flexible member connecting the inner and outer portions, the flexible member comprising at least one electrically conducting element adapted to transport electrical signals across the suspension member.

The suspension member is the soft part of a diaphragm whereas the piston, which is surrounded by and suspended in the surround, constitutes a significantly stiffer part of the diaphragm. Whereas the surround is adapted to be a flexible and deformable element of the diaphragm the piston is adapted to essentially maintain its shape during displacements. Thus, the piston is adapted to perform translational movements while essentially maintaining its shape as long as the displacements are performed within an intended frequency operating range, such as within a frequency range from 20 Hz to 20 kHz. However, the intended frequency operating range may also be significantly narrower.

The substantially stationary portion of the associated electro-acoustic transducer may be the housing of the electro-acoustic transducer or it may, alternatively, be a part of a magnetic circuit driving the diaphragm.

It is an advantage of the present invention that electrical signals may be transported across a moulded surround without putting the lead-out wires carrying the signals in danger.

It is a further advantage of the present invention that the surround material may be chosen independently of the piston material. This advantage provides the flexibility that the surround material may be chosen among soft materials whereas the piston material may be chosen among significantly stiffer materials. As a result, a combined surround and piston may be custom designed to have specific properties such as a diaphragm optimized to have a very low resonance frequency and a flat frequency response. Similarly, a stiffer piston material will cause the diaphragm to have a very large bandwidth.

The at least one conducting element may be adapted to transport signals between one or more circuits arranged on the substantially stationary portion side of the suspension member and one or more circuits arranged on the piston. Such signals may be power supply signals applied across the surround, data signals, such as clock signals or other synchronising signals, provided to or from electronic circuits positioned either on the piston or elsewhere in an associated electro-acoustic transducer housing, signals for driving one or more moving coils arranged on or integrated with the piston etc.

The inner portion of the suspension member may comprise an inner edge adapted to be attached to an associated outer edge of the piston. Thus, according to this embodiment the inner edge of the suspension member forms a through-going opening prior to the piston being attached to the suspension member. Alternatively, the inner portion of the suspension member may comprise a supporting surface adapted to be attached to an associated surface portion of the piston. The supporting surface of the suspension member may comprise an essentially plane surface portion. According to this embodiment, the suspension member comprises a supporting surface to which the piston may be glued, welded, or by other means attached.

The at least one electrically conducting element may be at least partly embedded into the flexible member having a first free end accessible at the inner portion and a second free end accessible at the outer portion of the suspension member. Preferably, the at least one electrically conducting element takes the form of a thin electrically conducting wire fully, except for the first and second free ends, embedded into the surround. The number of wires embedded into the surround can be adjusted depending on the specific application of the diaphragm. Thus, the number of wires may in principle be chosen arbitrary and the surround may thus comprise 1, 2, 4, 6, 10 or even a higher number of wires embedded into the surround.

The surround itself may comprise a material selected from the group consisting of: silicone, rubber, or any combination thereof. However, any soft material with the appropriate mechanical properties may, in principle, be used.

In terms of shape, the surround may, in principle, take any shape. Thus, the surround may take a substantially circular shape, a substantially oval shape, or a substantially rectangular shape. Combinations of these shapes are also applicable.

In a third aspect, the present invention relates to a diaphragm for an electro-acoustic transducer, the diaphragm comprising a suspension member and a piston. The suspension member may be in accordance with the second aspect of the present invention. The piston may be secured to the inner portion of the suspension member.

Thus, in the present content a diaphragm may be defined as an essentially stiff piston portion and a flexible surround surrounding and suspending the piston portion. The piston may comprise a material selected from a group consisting of: a polyimide, aluminium, polymer, such as nylon, or other materials having similar mechanical properties in terms of Young's modulus. Alternatively, the piston may be formed by a flex print, optionally with integrated coils arranged thereon.

In a fourth aspect, the present invention relates to a portable communication device comprising at least one electro-acoustic transducer according to the first aspect of the present invention, said portable communication device being selected from the group consisting of: cellular phones, PDAs (Personal Digital Assistants), game consoles, In-the-Ear Monitors (IEMs), hearing prosthesis's, and portable computers.

In a fifth aspect, the present invention relates to a method for manufacturing a suspension member according to the second aspect of the present invention, the method comprising the steps of:
providing one or more insert moulds, said one or more insert moulds being shaped so that a suspension member may be injection moulded in each of said one or more insert moulds, and
providing a lead-out wire, and positioning said lead-out wire so that at least part or parts of said lead-out wire is/are positioned in at least two neighbouring insert moulds.

The method may further comprise the step of injection moulding one or more suspension members by providing an injection mouldable material into the one or more insert moulds. The injection mouldable material may be selected from the group consisting of: silicone, rubber, or any combination thereof. Following the step of injection moulding one or more suspension members the method may further comprise the step of disconnecting a lead-out wire or lead-out wires between neighbouring insert moulds.

By applying the method according to the fifth aspect of the present invention integrated lead-out wires may easily be embedded into a plurality of surrounds by positioning an unbroken lead-out wire across a plurality of injection moulds and injection moulding one or more surrounds by providing an injection mouldable material into the one or more insert moulds. After the injection moulding process the surrounds are separated by cutting the wires which interconnects them.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE INVENTION

The present invention will now be explained in further details with reference to the accompanying figures, wherein

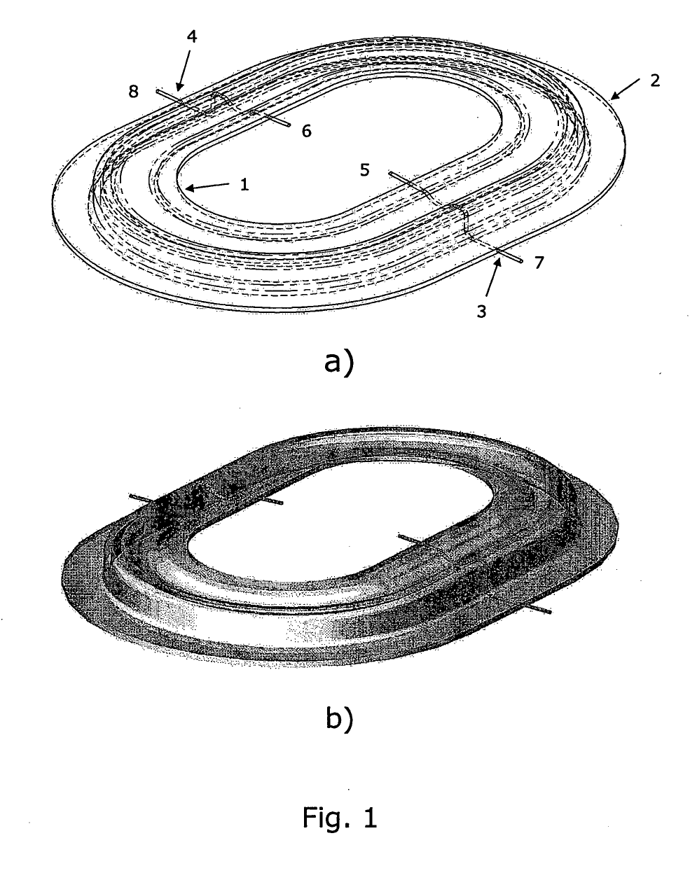

FIG. 1 shows a first embodiment of the present invention,

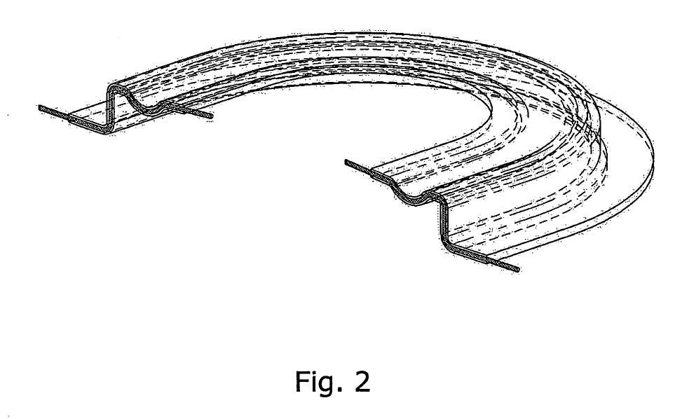

FIG. 2 shows a cross-sectional view of the first embodiment,

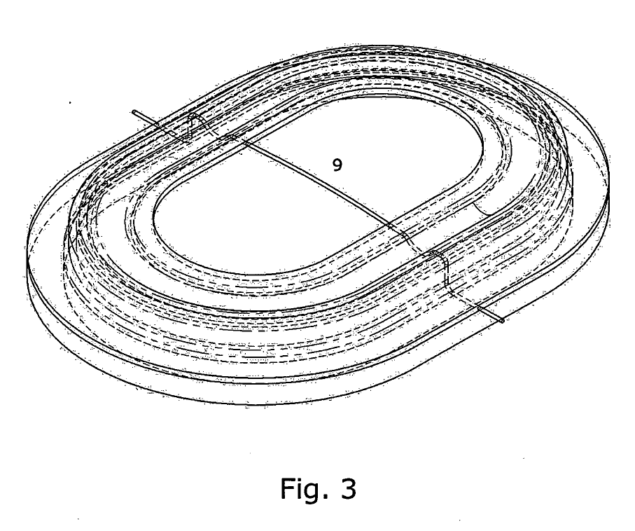

FIG. 3 shows the first embodiment of the present invention with a through-going lead-out wire,

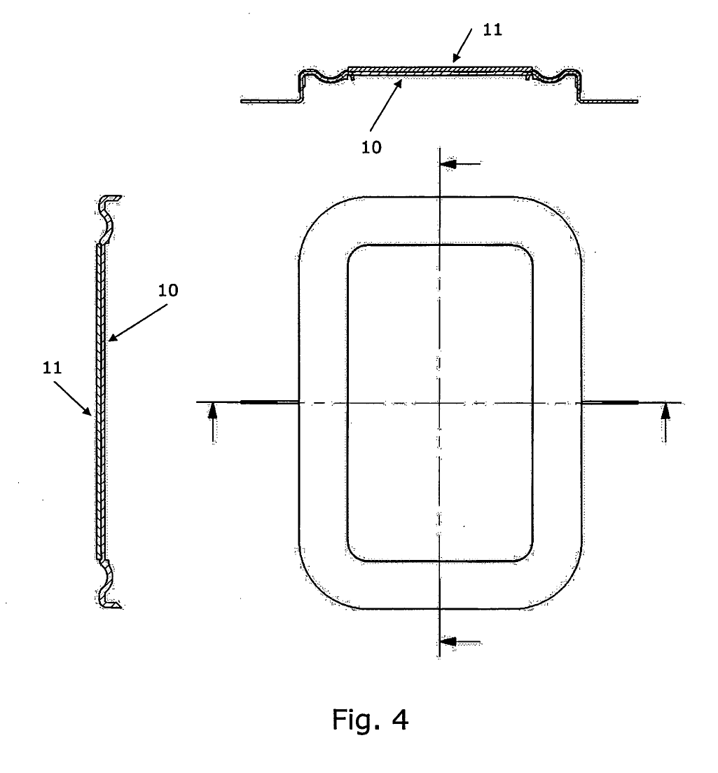

FIG. 4 shows a cross-sectional view of a second embodiment of the present invention,

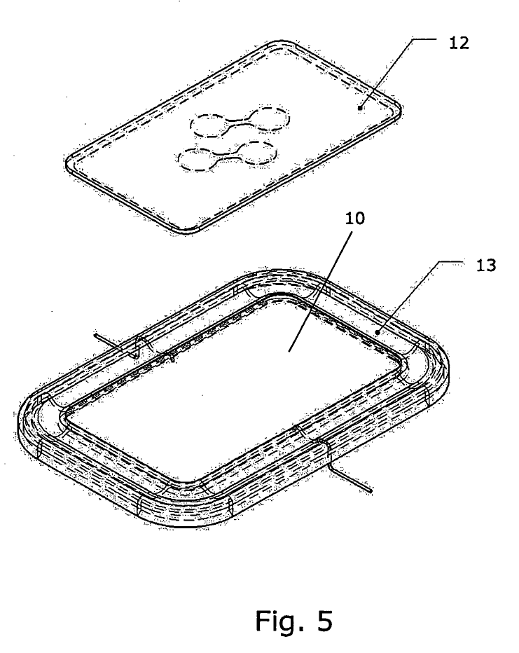

FIG. 5 shows the second embodiment of the present invention,

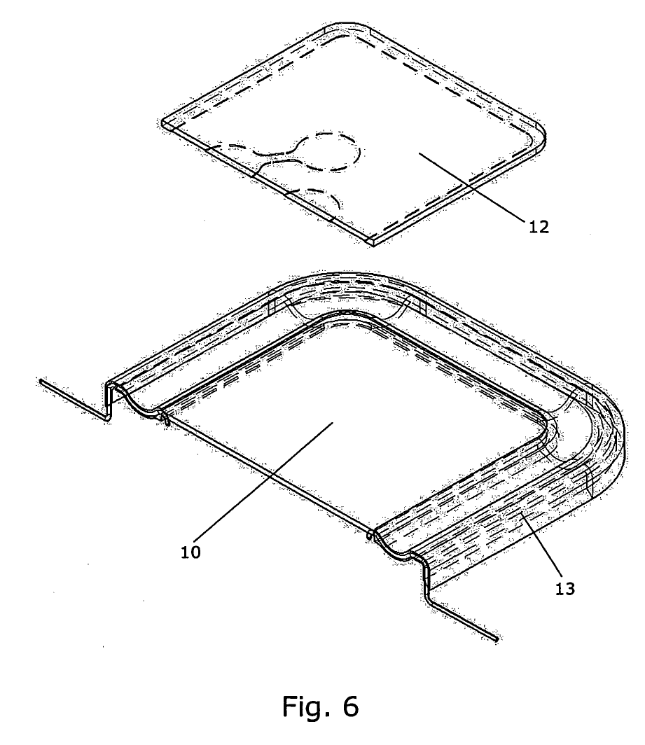

FIG. 6 shows a cross-sectional view of the second embodiment of the present invention, and

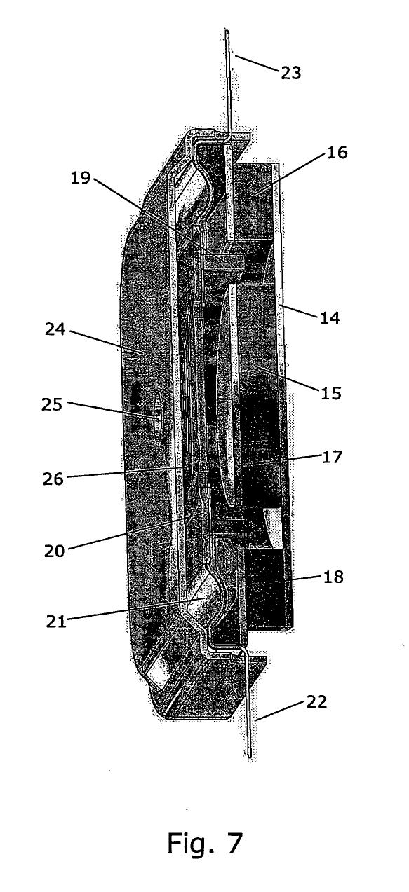

FIG. 7 shows a cross-sectional view of an electro-acoustic transducer according to the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

In its most general aspect the present invention relates to a moulded surround with at least one integrated lead-out wire. The lead-out wire is integrated for provided an electrical connection across the moulded surround.

The moulded surround according to the present invention is depicted in FIG. 1. As seen, the surround has an inner edge 1 and an outer edge 2. The inner edge 1 is adapted for being attached to a piston part (not shown) whereas the outer edge 2 is adapted for being attached to a stiff portion of a magnetic circuit. The piston can be attached to the moulded surround by means such as, for example, gluing, heating or ultrasound-based welding.

Two integrated lead-out wires 3, 4 are depicted in FIG. 1. Each of these lead-out wires has an inner end 5, 6 and an outer end 7, 8. The inner ends 5, 6 are adapted to be electrically connected to electrical elements/circuits arranged on a piston attached to the inner edge 1. Such electrical elements/circuit can be wounded coils, such as voice coils or other moving coils, ASICs or other kinds of electronic circuits. Also, the number of lead-out wires can differ from the two lead-out wires depicted in FIG. 1. Thus, in an embodiment where an ASIC is arranged on the piston, lead-out wires for power supply, clock signals, data signals, etc., may be provided in order to transport electrical signals across the moulded surround.

The moulded surround itself is made of a soft material, such as silicone, rubber, or a similar soft material, and this material can be chosen independently of the piston material. The piston to be attached to the surround is typically made of a stiffer material, such as Kapton® polyimide material, aluminium, nylon, flex print, etc.

The technique according to the present invention allows integration of lead-out wires into the surround so that the integrated lead-out wires are ready for contacting to, for example, a voice coil which, at a later stage, will be attached to the piston area.

By feeding the lead-out wire into the insert mould, the lead-out wire can be moulded into the surround and thereby form an integrated part of it. This is advantageous because the lead-out wires in miniature electro-acoustic transducers are a weak spot in the construction and tend to break under severe power and displacement conditions. By integrating the lead-out wires into the surround, the lead-out wires are protected and controlled in their movement which will result in an optimal reliability.

FIG. 2 shows a cross-sectional view of a moulded surround with two integrated lead-out wires. As already mentioned, the number of lead-out wires can differ from two dependent on the specific applications of the surround.

Referring now to FIG. 3 a moulded surround with a through-going lead-out wire 9 is depicted. This through-going lead-out wire is a result of an advantageous fabrication technique where a series of injection moulds are positioned next to each other and where a single wire is positioned across all moulds. By applying this fabrication technique a series of moulded surrounds with a through-going integrated lead-out wire or lead-out wires can be manufactured. Naturally, the through-going lead-out wire 9 shown in FIG. 3 needs to be cut so that the free wire ends can be connected to for example a voice coil attached to the piston.

FIG. 4 shows cross-sectional views of an alternative embodiment of the present invention. In this embodiment a supporting surface 10 is moulded together with the surround. Thus, the supporting surface 10 is moulded in the same process where also the surround itself is moulded. The supporting surface 10 forms a supporting surface for mounting a piston 11 so that a better support for this piston is achieved. The piston can be attached to the support 10 (or to the inner edge 1 of FIG. 1) by means such as, for example, gluing, heating or ultrasound-based welding.

FIGS. 5 and 6 show how the piston 12 is mounted on the supporting surface 10 of the surround 13. Again, the piston can be attached to the surround by means such as, for example, gluing, heating, or ultrasound-based welding.

FIG. 7 shows a cross-sectional view of an electro-acoustic transducer according to the present invention. As depicted in FIG. 7, the electro-acoustic transducer comprises a motor comprising a yoke 14, a centre magnet 15, an annular magnet 16, a centre pole piece 17, an outer pole piece 18, and a voice coil 19 positioned in an air gap between the centre pole piece 17 and the outer pole piece 18. The voice coil 19 is attached to the piston 20, the latter forming part of a displaceable diaphragm also comprising the surround 21 having at least two integrated lead-out wires 22, 23 integrated therein. A cover 24 having one or more acoustical outlets 25 arranged therein protects the diaphragm. The piston 20 of the diaphragm depicted in FIG. 7 carries an electronic device 26 in form of the coil arranged on the upper surface of the piston 20. This coil may be adapted for establishing a coupling to a T-coil of an external hearing aid. As already mentioned the lead-outs 22, 23 are adapted to allow electrical signals to be transported across the surround 21 to the planar coil 26 and the voice coil 19. In case for example an ASIC is arranged on the piston 20 as well additional lead-outs are required in order to transport signals to and from said ASIC.

The moulded surrounds depicted in FIGS. 1-7 are all illustrated as being oval or rectangular in shape. However, the moulded surround may, in principle, take any shape such as circular, elliptical, quadratic, or any other shape.

While the present invention has been described with reference to one or more particular embodiments, those skilled in the art will recognize that many changes may be made thereto without departing from the spirit and scope of the present invention. Each of these embodiments and obvious variations thereof is contemplated as falling within the scope of the claimed invention, which is set forth in the following claims.

1. An electro-acoustic transducer comprising:
a displaceable diaphragm comprising a suspension member and a piston, wherein the suspension member comprises,
an inner portion supporting the piston,
an outer portion secured to a substantially stationary portion of the electro-acoustic transducer, and
a flexible member connecting the inner and outer portions, the flexible member comprising at least one electrically conducting element adapted to transport electrical signals across the suspension member; and
an electro-mechanical motor adapted to generate an electrical output signal in response to displacements of the diaphragm, or to displace the diaphragm in response to an electrical input signal.

2. An electro-acoustic transducer according to claim 1, wherein the electro-mechanical motor comprises a magnetic circuit adapted to generate a magnetic flux in an air gap.

3. An electro-acoustic transducer according to claim 2, further comprising an electrically conducting voice coil comprising first and second end portions, wherein the voice coil is operatively connected to the diaphragm and, at least partly, positioned in the air gap, and wherein the first and second end portions of the voice coil are electrically connected to first and second electrically conducting elements, respectively.

4. An electro-acoustic transducer according to claim 1, wherein the electro-mechanical motor comprises means for generating a magnetic field in response to an electrical input signal, and a mechanical drive member operatively connected to the diaphragm, said mechanical drive member being movable in response to the electrical input signal.

5. An electro-acoustic transducer according to claim 1, wherein the inner portion of the suspension member comprises an inner edge, said inner edge being attached to an associated outer edge of the piston.

6. An electro-acoustic transducer according to claim 1, wherein the inner portion of the suspension member comprises a supporting surface attached to an associated surface portion of the piston.

7. An electro-acoustic transducer according to claim 6, wherein the supporting surface of the suspension member comprises an essentially plane surface portion.

8. An electro-acoustic transducer according to claim 1, wherein the at least one electrically conducting element is at least partly embedded into the flexible member.

9. An electro-acoustic transducer according to claim 1, wherein the flexible member comprises a material selected from the group consisting of: silicone, rubber, or any combination thereof.

10. A suspension member for a diaphragm, the suspension member comprising:
an inner portion being adapted to support a piston;
an outer portion being adapted to be secured to a substantially stationary portion of an associated electro-acoustic transducer; and
a flexible member connecting the inner and outer portions, the flexible member comprising at least one electrically conducting element adapted to transport electrical signals across the suspension member.

11. A suspension member according to claim 10, wherein the inner portion comprises an inner edge, said inner edge being adapted to be attached to an associated outer edge of the piston.

12. A suspension member according to claim 10, wherein the inner portion comprises a supporting surface, said supporting surface being adapted to be attached to an associated surface portion of the piston.

13. A suspension member according to claim 12, wherein the supporting surface portion comprises an essentially plane surface portion.

14. A suspension member according to claim 10, wherein the at least one electrically conducting element is at least partly embedded into the flexible member.

15. A suspension member according to claim 10, wherein the at least one electrically conducting element has a first free end accessible at the inner portion of the suspension member, and a second free end accessible at the outer portion of the suspension member.

16. A suspension member according to claim 10, comprising two, four, or six electrically conducting elements.

17. A suspension member according to claim 10, wherein the flexible member comprises a material selected from the group consisting of: silicone, rubber, or any combination thereof.

18. A suspension member according to claim 10, wherein the suspension member takes a substantially circular, a substantially oval, or a substantially rectangular shape.

19. A diaphragm for an electro-acoustic transducer, the diaphragm comprising:
a suspension member according to claim 10; and
a piston secured to the inner portion of the suspension member.

20. A diaphragm according to claim 19, wherein the piston comprises a material selected from the group consisting of: a polyimide, aluminium, polymer, and nylon.

21. A diaphragm according to claim 20, wherein the piston comprises a flex print.

22. A portable communication device comprising at least one electro-acoustic transducer according to claim 1, said portable communication device being selected from the group consisting of: cellular phones, Personal Digital Assistants (PDAs), game consoles, In-the-Ear Monitors (IEMs), hearing prostheses, and portable computers.

23. A method for manufacturing a suspension member according to claim 10, the method comprising the steps of:
providing one or more insert moulds, said one or more insert moulds being shaped so that a suspension member may be injection moulded in each of said one or more insert moulds; and
providing a lead-out wire, and positioning said lead-out wire so that at least part or parts of said lead-out wire is/are positioned in at least two neighbouring insert moulds.

24. A method according to claim 23, further comprising the step of injection moulding one or more suspension members by providing an injection mouldable material into the one or more insert moulds.

25. A method according to claim 24, further comprising the step of disconnecting a lead-out wire or lead-out wires between neighbouring insert moulds.

26. A method according to claim 24, wherein the injection mouldable material is selected from the group consisting of: silicone, rubber, or any combination thereof.
